(19) United States
(12) Patent Application Publication
(10) Pub. No.: US 2011/0274456 A1
(43) Pub. Date: Nov. 10, 2011

(54) IMAGE FORMING APPARATUS AND METHOD OF CONTROLLING IMAGE FORMING APPARATUS

(75) Inventors: Natsuyo HIGASHI, Toyokawa-shi (JP); Akinori KIMATA, Toyokawa-shi (JP); Satoru SASAKI, Toyokawa-shi (JP); Hirotada SEKI, Toyokawa-shi (JP); Hiroaki TAKATSU, Nishio-shi (JP)

(73) Assignee: Konica Minolta Business Technologies, Inc., Chiyoda-ku (JP)

(21) Appl. No.: 13/092,508

(22) Filed: Apr. 22, 2011

(30) Foreign Application Priority Data
May 10, 2010 (JP) 2010-108169

(51) Int. Cl. G03G 15/00

(52) U.S. Cl. 399/88

(57) ABSTRACT

An image forming apparatus includes a fixing device having a heater, a signal generator for generating a prescribed cyclic signal in conformity with a waveform of an AC power supply applied to the heater, and a controller for controlling power feed to the heater. The controller determines whether a cycle of the prescribed cyclic signal becomes shorter than a prescribed period or not. When the controller has determined that the cycle has become shorter than the prescribed period, the controller controls power feed to the heater under phase control and when the controller has determined that the cycle has not become shorter than the prescribed period, the controller controls power feed to the heater under zero crossing control.

This application is based on Japanese Patent Application No. 2010-108169 filed with the Japan Patent Office on May 10, 2010, the entire content of which is hereby incorporated by reference.

### BACKGROUND OF THE INVENTION

1. Field of the Invention

The present invention relates to an image forming apparatus and a method of controlling an image forming apparatus, and particularly to an image forming apparatus including a fixing device having an electric heater and a method of controlling an image forming apparatus.

2. Description of the Related Art

An image forming apparatus of an electrophotographic type such as a printer and a copying machine includes a fixing device for fixing a toner image transferred onto recording paper through various steps to the recording paper by means of heat and pressure.

In general, the fixing device includes an electric heater such as a halogen lamp supplying heat for fusing toner. For power feed control of such an electric heater, what is called zero crossing control or phase control is adopted.

Here, zero crossing control refers to a control method of feeding power every half wave by making switching at the moment when a voltage of an AC power supply comes closer to zero (zero crossing point). On the other hand, phase control refers to a control method of feeding power while a time period of power feed is finely adjusted by making switching at a prescribed phase angle.

When an environment where an image forming apparatus is used is in an overloaded state, an AC power supply voltage may become unstable, and Japanese Laid-Open Patent Publication No. 2004-013668 proposes power feed control under phase control in which a malfunction is prevented when a power supply voltage is unstable.

In addition, when an environment where an image forming apparatus is used is temporarily in an overloaded state and a power supply voltage becomes unstable, such a malfunction as flickering of a fluorescent lamp in the same environment of use may occur. In particular, a fluorescent lamp without including an inverter is more likely to be affected.

In order to address this, Japanese Laid-Open Patent Publication No. 09-101718 proposes a technique to switch between zero crossing control and phase control so that a power supply voltage is prevented from becoming unstable in power feed control of an electric heater.

The technique shown in Japanese Laid-Open Patent Publication No. 09-101718 above, however, determines whether a power supply voltage becomes unstable or not by using a voltage peak detection circuit and switches power feed control based on a signal from the circuit. Namely, a configuration is complicated and the technique is disadvantageous also in terms of cost.

### SUMMARY OF THE INVENTION

The present invention was made to solve the problems as above, and an object of the present invention is to provide an image forming apparatus capable of preventing, with a simplified technique, a power supply voltage from becoming unstable due to power feed to an electric heater provided therein.

An image forming apparatus according to one aspect of the present invention includes a fixing device having a heater, a signal generator for generating a prescribed cyclic signal in conformity with a waveform of an AC power supply applied to the heater, and a controller for controlling power feed to the heater. The controller determines whether a cycle of the prescribed cyclic signal becomes shorter than a prescribed period, and when the controller has determined that the cycle has become shorter than the prescribed period, the controller controls power feed to the heater under phase control, and when the controller has determined that the cycle has not become shorter than the prescribed period, the controller controls power feed to the heater under zero crossing control.

Preferably, the signal generator generates a zero crossing signal in conformity with the waveform of the AC power supply.

Preferably, the controller causes power feed to the heater at a predetermined phase angle of the AC power supply.

Preferably, the controller determines whether or not the cycle of the prescribed cyclic signal becomes shorter than the prescribed period when power is fed to the heater.

A method of controlling an image forming apparatus provided with a fixing device having a heater according to one aspect of the present invention includes a step of generating a prescribed cyclic signal in conformity with a waveform of an AC power supply applied to the heater, a step of feeding power to the heater, a step of determining whether or not a cycle of the prescribed cyclic signal becomes shorter than a prescribed period, and a control step of controlling power feed to the heater under phase control when it has been determined that the cycle has become shorter than the prescribed period and controlling power feed to the heater under zero crossing control when it has been determined that the cycle has not become shorter than the prescribed period.

Preferably, in the step of generating a prescribed cyclic signal, a zero crossing signal in conformity with the waveform of the AC power supply is generated.

Preferably, in the step of feeding power to the heater, power is fed to the heater at a predetermined phase angle of the AC power supply.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of a printer serving as an image forming apparatus according to an embodiment of the present invention.

FIG. 2 is a schematic diagram of the printer according to the embodiment of the present invention, with a print portion being shown in the center.

FIG. 3 is a block diagram showing a configuration of a power supply portion of the printer according to the embodiment of the present invention.

FIG. 4 is a flowchart showing a processing procedure of the printer according to the embodiment of the present invention.

FIG. 5 is a diagram illustrating one example of a voltage waveform and the like when a heater lamp according to the embodiment of the present invention is turned on.

FIG. 6 is a diagram illustrating another example of a voltage waveform and the like when the heater lamp according to the embodiment of the present invention is turned on.

FIG. 7 is a diagram illustrating electric power supplied to the heater lamp in phase control.

FIG. 8 is a diagram illustrating a phase control signal in phase control.

### DESCRIPTION OF THE PREFERRED EMBODIMENTS

An embodiment of the present invention will be described hereinafter with reference to the drawings. The same parts and components have the same reference characters allotted, and their label and function are also identical.

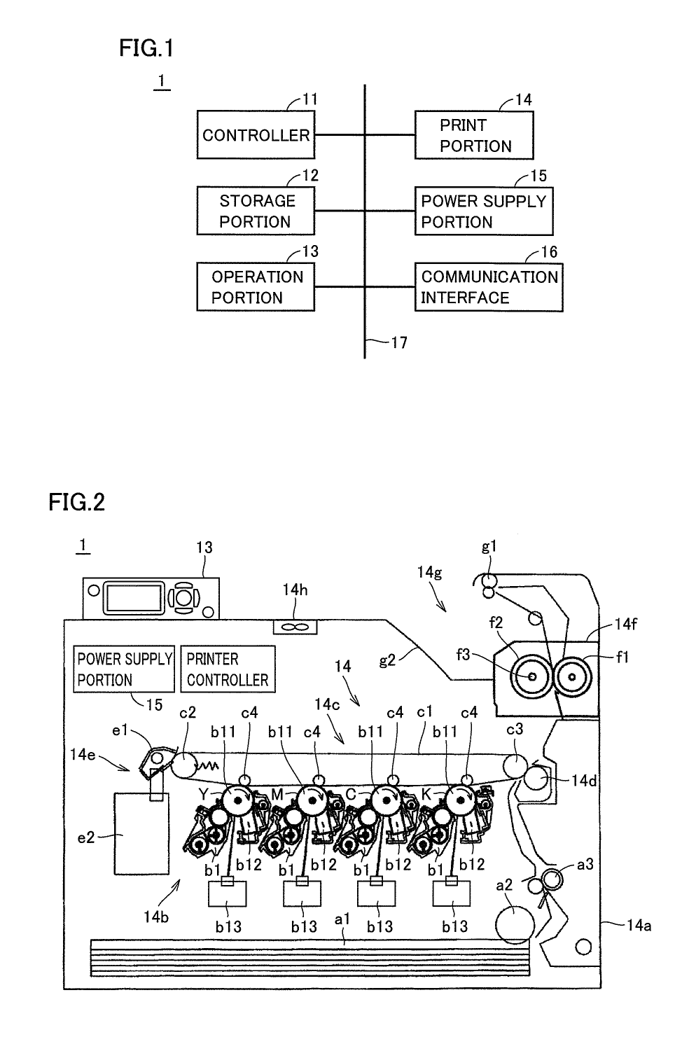

A configuration of a printer 1 serving as an image forming apparatus according to an embodiment of the present invention will be described with reference to FIG. 1.

Referring to FIG. 1, printer 1 includes a controller 11, a storage portion 12, an operation portion 13, a print portion 14, a power supply portion 15, and a communication interface 16, and these components are connected to one another through a bus 17 for exchanging a signal.

Controller 11 is implemented by a CPU (Central Processing Unit) serving as control means, and controls each portion above or performs various types of operation processing or the like in accordance with a program.

Storage portion 12 is constituted of a ROM (Read Only Memory) for storing various programs or parameters in advance, a RAM (Random Access Memory) serving as a work area for temporarily storing a program or data, a hard disk used for storing various programs or parameters or temporarily saving image data or the like obtained by image processing, and the like.

Operation portion 13 is constituted of a touch panel for displaying various types of information or accepting various setting inputs, various fixed keys such as a numeric keypad for setting the number of copies, a start key for indicating start of an operation, a stop key for indicating stop of an operation, and a reset key for initializing various setting conditions, an indicator, and the like.

Print portion 14 prints image data on a sheet of paper through each step of charging, exposure, development, transfer, and fixing with electrophotography and ejects the paper. Details of print portion 14 will further be described later.

Power supply portion 15 regulates a voltage of an external AC power supply to a voltage necessary for driving each portion in printer 1. Specifically, power supply portion 15 has a function to transform an AC voltage, convert an AC voltage to a predetermined DC voltage, regulate electric power by the AC voltage, or remove power supply noise. Details of power supply portion 15 will further be described later.

Communication interface 16 is an interface for communication between printer 1 and external equipment, and various local connection interfaces including a network interface complying with such specifications as Ethernet®, token ring and FDDI (Fiber-Distributed Data Interface), a serial interface such as USB (Universal Serial Bus) and IEEE (Institute of Electrical and Electronics Engineers) 1394, a parallel interface such as SCSI (Small Computer System Interface) and IEEE 1284, a wireless communication interface such as Bluetooth, IEEE 802.11, HomeRF (Radio Frequency), IrDA (Infrared Data Association), and the like, a telephone line interface for connection to a telephone line, and the like are employed.

According to the configuration above, printer 1 can provide print output on recording paper or the like based on a print job received from external equipment. It is noted that controller 11, storage portion 12 and communication interface 16 are normally mounted on printer 1 as a printer controller for receiving a print job from external equipment and generating image data that can be processed by print portion 14 (see FIG. 2).

In succession, print portion 14 of printer 1 according to the embodiment of the present invention will be described in further detail.

The image forming apparatus according to the embodiment of the present invention will be described hereinafter with reference to a tandem-type color printer (simply also referred to as a printer).

Printer 1 according to the embodiment of the present invention will be described with reference to FIG. 2. Here, print portion 14 is shown in the center.

As shown in FIG. 2, print portion 14 serves to form an image on recording paper with electrophotography.

Print portion 14 includes a paper feed portion 14a for containing and conveying recording paper, an imaging portion 14b of yellow (Y), magenta (M), cyan (C), and black (K), an intermediate transfer unit 14c for forming a toner image on an intermediate transfer belt c1 which will be described later, a secondary transfer roller 14d for transferring the toner image formed on intermediate transfer belt c1 onto the recording paper, a cleaning unit 14e for removing and recovering toner attached to intermediate transfer belt c1, a fixing device 14f for fusing the toner image and attaching and fixing the same to the recording paper, and a paper ejection portion 14g for ejecting the recording paper to which the toner image has been fixed to the outside of the printer and storing the same. In addition, printer 1 according to the present embodiment has a cooling fan 14h for cooling the inside of the apparatus.

Paper feed portion 14a includes a paper feed cassette a1 for accommodating recording paper, a paper feed roller a2 for feeding recording paper from paper feed cassette a1, and a register roller a3 for providing timing to forward upward shown in the drawing, recording paper fed by paper feed roller a2.

Imaging portion 14b includes a development device b1 of Y, M, C, and K, and each development device b1 is provided with a photoconductor drum b11 composed of a-Si (amorphous silicon) or the like, a charging portion b12 for charging photoconductor drum b11, and an exposure portion b13 for exposing charged photoconductor drum b11 so as to form an electrostatic latent image on a surface of photoconductor drum b11. Each photoconductor drum b11 is provided to be rotatable in a direction of an arrow in the drawing.

Intermediate transfer unit 14c has intermediate transfer belt c1, a drive roller c2 and a driven roller c3 between which intermediate transfer belt c1 is stretched, and a transfer roller c4 for transferring the toner image formed on photoconductor drum b11 onto intermediate transfer belt c1. Drive roller c2 is rotatably driven by a not-shown motor or the like, intermediate transfer belt c1 rotates together with this drive roller c2, and further, driven roller c3 is rotated together with intermediate transfer belt c1. In addition, intermediate transfer belt c1 is in such a state as pressed against each photoconductor drum b11 by transfer roller c4.

Secondary transfer roller 14d is arranged such that intermediate transfer belt c1 is sandwiched between secondary transfer roller 14d and driven roller c3.

Cleaning unit 14e has a cleaning device el for removing toner attached to intermediate transfer belt c1 and a toner storage box e2 for recovering toner removed by cleaning device e1.

Fixing device 14f has a pressure roller f1, a heating roller f2 opposed to pressure roller f1, and a heater lamp f3 serving as an electric heater provided inside heating roller f2. Pressure roller f1 forms a nipping portion pressed against heating roller f2 at a predetermined pressure for sandwiching recording paper at a portion of contact with heating roller f2. Heating roller f2 is rotatably driven by a not-shown motor or the like while a temperature of its surface is increased to a predetermined temperature by heater lamp f3. A halogen lamp represents one example of the heater lamp. As recording paper conveyed from secondary transfer roller 14d passes the nipping portion, unfixed toner on the recording paper is fused to penetrate by the heat and the pressure at the nipping portion so that the toner image is fixed to the recording paper.

Paper ejection portion 14g has an ejection roller g1 for ejecting the recording paper conveyed from fixing device 14f to the outside and a paper ejection tray g2 for storing the recording paper ejected by ejection roller g1.

Cooling fan 14h dissipates heat in printer 1 to the outside as the fan rotates. Cooling fan 14h prevents the inside of printer 1 from reaching an excessively high temperature due to the heat generated by print portion 14 or power supply portion 15.

In succession, power supply portion 15 of printer 1 according to the present embodiment will be described in further detail.

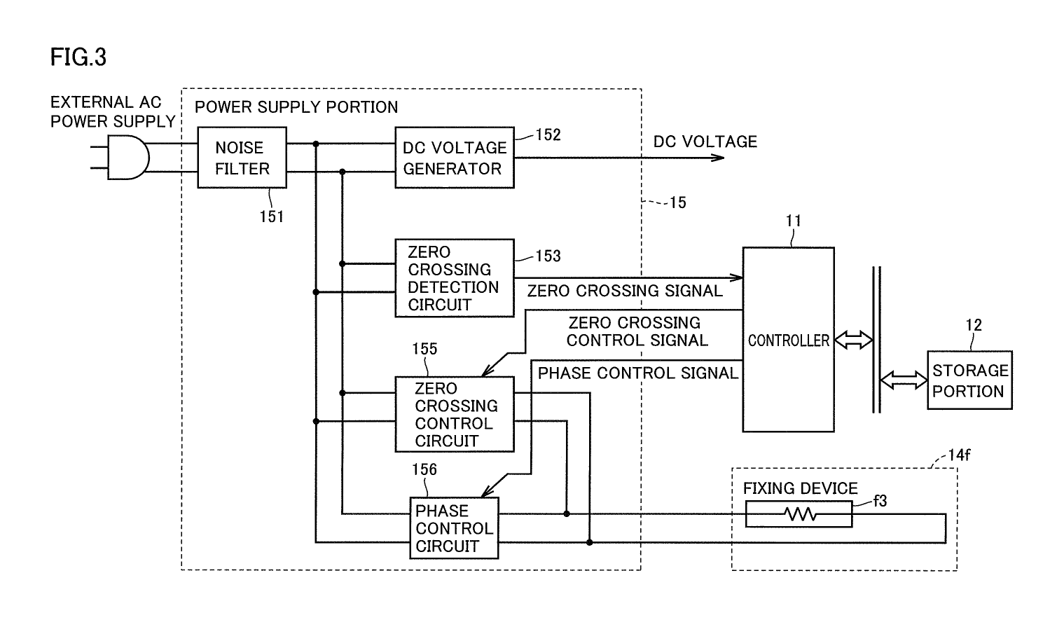

A configuration of power supply portion 15 of printer 1 according to the embodiment of the present invention will be described with reference to FIG. 3.

Referring to FIG. 3, power supply portion 15 has a noise filter 151, a DC voltage generator 152, a zero crossing detection circuit 153, a zero crossing control circuit 155, and a phase control circuit 156.

Noise filter 151 removes noise in the external AC power supply to which power supply portion 15 is connected. DC voltage generator 152 generates a predetermined DC voltage (+5V, +24V or the like) based on an AC voltage of the external AC power supply.

Zero crossing detection circuit 153 is a circuit for detecting a zero crossing point of the external AC power supply, and when it detects the zero crossing point, it transmits a zero crossing signal which is a prescribed cyclic signal to controller 11. It is noted that a cycle of the prescribed cyclic signal is varied in accordance with a frequency of the external AC power supply. For example, when the external AC power supply has a frequency of 60 Hz, a zero crossing time period representing a cycle of the zero crossing signal is 8.3 ms. Meanwhile, when the external AC power supply has a frequency of 50 Hz, a zero crossing time period representing a cycle of the zero crossing signal is 10 ms.

Zero crossing control circuit 155 receives a zero crossing control signal from controller 11 and carries out zero crossing control of power feed to heater lamp f3.

Phase control circuit 156 receives a phase control signal from controller 11 and carries out phase control of power feed to the heater lamp.

According to zero crossing control circuit 155, switching is always made around a zero voltage of the AC power supply, so that an inrush current to heater lamp f3 can be prevented and switching noise can be reduced.

Control by zero crossing control circuit 155, however, is always carried out every half wave. Therefore, such a disadvantage that the AC power supply temporarily enters an overloaded state due to power feed to heater lamp f3 and the power supply voltage becomes unstable may be caused. Specifically, such a malfunction as flickering of a fluorescent lamp in the same power supply environment may occur.

Then, printer 1 according to the embodiment of the present invention detects whether the power supply voltage is in the overloaded state or not with a specific technique. When determination as being in the overloaded state is made, phase control circuit 156 rather than zero crossing control circuit 155 controls power feed to heater lamp f3.

Phase control circuit 156 can finely adjust a time period of power feed to heater lamp f3 by controlling a phase angle at which switching is made. Therefore, electric power supply to heater lamp f3 can gradually be increased (slow-up) by setting a sufficiently short time period of power feed, thus preventing the power supply voltage from becoming unstable.

An operation for controlling power feed to heater lamp f3 within fixing device 14f in printer 1 according to the embodiment of the present invention will now be described.

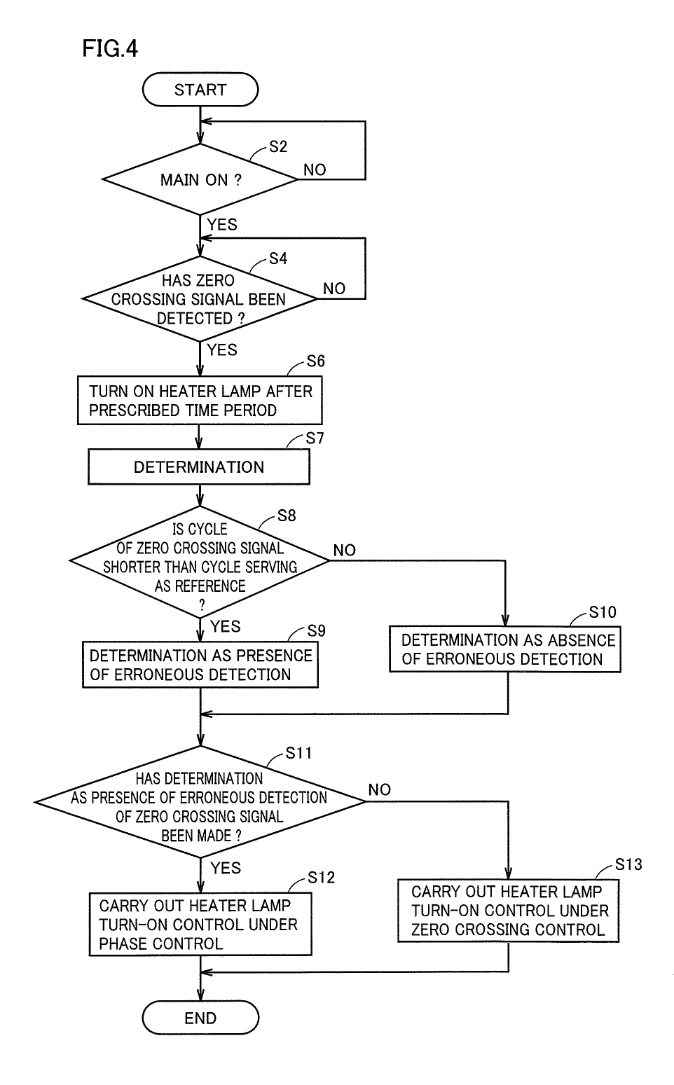

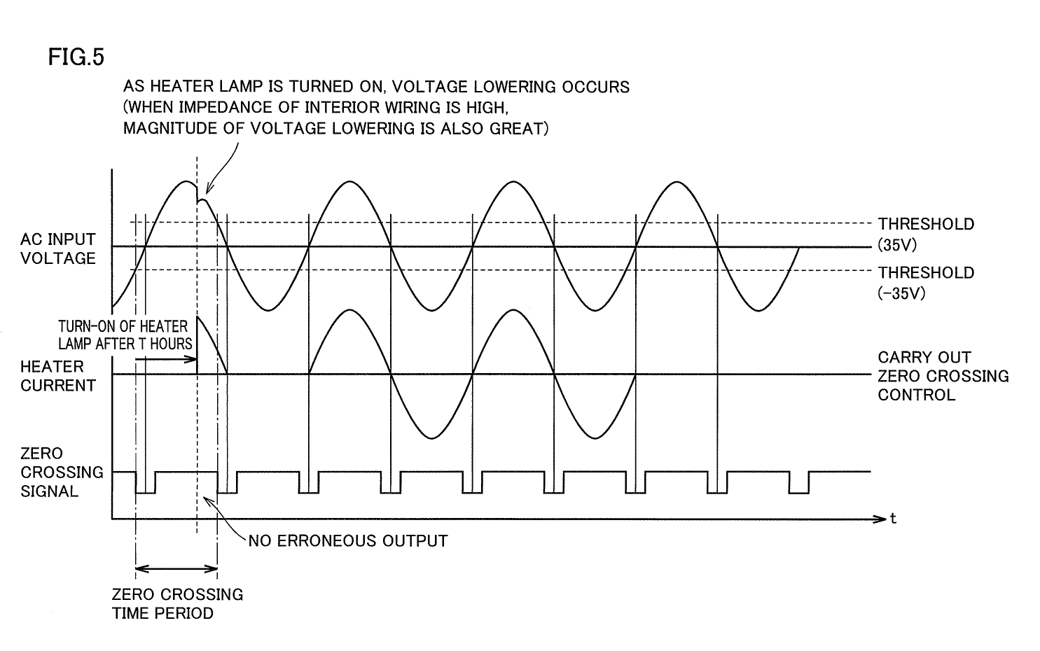

A processing procedure of printer 1 according to the embodiment of the present invention will be described with reference to FIG. 4.

It is noted that an algorithm shown in the flowchart in FIG. 4 is stored in storage portion 12 as a control program and it is read and executed by controller 11 when the operation is started.

Initially, printer 1 determines whether a main switch has been turned on or not (step S2). When the main switch has been turned on, printer 1 then determines whether a zero crossing signal is detected or not (step S4). Specifically, determination is made based on whether a zero crossing signal in conformity with the external AC power supply that is generated by zero crossing detection circuit 153 is input to controller 11 or not.

When controller 11 does not detect a zero crossing signal (NO in step S4), it stands by. When controller 11 detects the zero crossing signal (YES in step S4), it turns on heater lamp f3 after a prescribed time period (step S6). Heater lamp f3 is turned on after this prescribed time period, for example, under phase control with a prescribed phase angle being set in advance.

Then, controller 11 determines a cycle of the zero crossing signal (step S7). Specifically, controller 11 determines whether or not a cycle of the zero crossing signal has been varied with turn-on of heater lamp f3.

Then, controller 11 determines whether or not a cycle of the zero crossing signal (zero crossing time period) is shorter than a cycle serving as the reference (step S8). For example, when the external AC power supply has a frequency of 60 Hz, a zero crossing time period representing a cycle serving as the reference of the zero crossing signal is 8.3 ms. Meanwhile, when the external AC power supply has a frequency of 50 Hz, a zero crossing time period representing a cycle serving as the reference of the zero crossing signal is 10 ms.

When controller 11 determines in step S8 that the cycle of the zero crossing signal (zero crossing time period) is shorter than the cycle serving as the reference, determination as presence of erroneous detection is made (step S9).

On the other hand, when controller 11 did not determine in step S8 that the cycle of the zero crossing signal (zero crossing time period) is shorter than the cycle serving as the reference, determination as absence of erroneous detection is made (step S10).

Then, controller 11 determines whether determination as presence of erroneous detection of the zero crossing signal has been made or not (step S10).

Then, when controller 11 determined that determination as presence of erroneous detection of the zero crossing signal was made (YES in step S11), it determines that the power supply voltage is likely to become unstable and controls turn-on of the heater lamp under phase control (step S12). Specifically, in order to carry out phase control of heater lamp f3, a phase control signal is transmitted from controller 11 to phase control circuit 156. Then, phase control circuit 156 that has received the phase control signal from controller 11 carries out phase control of power feed to heater lamp f3. Thus, as electric power supplied to heater lamp f3 is gradually increased (slow-up) under phase control, occurrence of such a malfunction as flickering of a fluorescent lamp due to the AC voltage becoming unstable can be prevented.

On the other hand, when controller 11 determined that determination as absence of erroneous detection of the zero crossing signal was made (NO in step S11), it determines that the power supply voltage is less likely to become unstable and controls turn-on of the heater lamp under zero crossing control (step S13). Specifically, in order to carry out zero crossing control of heater lamp f3, a zero crossing control signal is transmitted from controller 11 to zero crossing control circuit 155. Then, zero crossing control circuit 155 that has received the zero crossing control signal from controller 11 carries out zero crossing control of power feed to heater lamp f3.

Then, the process ends (end).

One example of a voltage waveform and the like when heater lamp f3 according to the embodiment of the present invention is turned on will be described with reference to FIG. 5.

Referring to FIG. 5, here, a voltage waveform of an AC input voltage representing the external AC power supply, a heater current that flows in heater lamp f3, and a waveform of the zero crossing signal are shown.

As shown in FIG. 5, a zero crossing signal in conformity with the voltage waveform of the AC input voltage is output from zero crossing detection circuit 153. Specifically, when the AC input voltage is not lower than 35V in accordance with the threshold (threshold value) of +35V, −35V, the zero crossing signal is output at the “H” level, and when the AC input voltage is lower than 35V, the zero crossing signal is output at the “L” level. In the present embodiment, the external AC power supply is assumed to have a frequency of 50 Hz. In this case, the zero crossing time period representing the cycle of the zero crossing signal is 10 ms.

When the zero crossing signal is detected in accordance with the flow in FIG. 4, for example, when the “L” level of the zero crossing signal is detected, heater lamp f3 is turned on after a prescribed time period T.

With this turn-on, voltage lowering in the AC input voltage occurs. Here, when impedance of interior wiring representing an environment where printer 1 is used is high (overloaded state), magnitude of voltage lowering is great.

Here, a case where voltage lowering is small is shown. Therefore, since voltage lowering at the time of turn-on of heater lamp f3 is small, it does not affect the cycle of the zero crossing signal. Thus, assuming that erroneous detection of the zero crossing signal is absent (NO in step S11), turn-on of heater lamp f3 is controlled under zero crossing control. By carrying out zero crossing control, efficiency in turn-on of the heater can be enhanced and a period required to increase a temperature of heater lamp f3 to a prescribed temperature can be shortened.

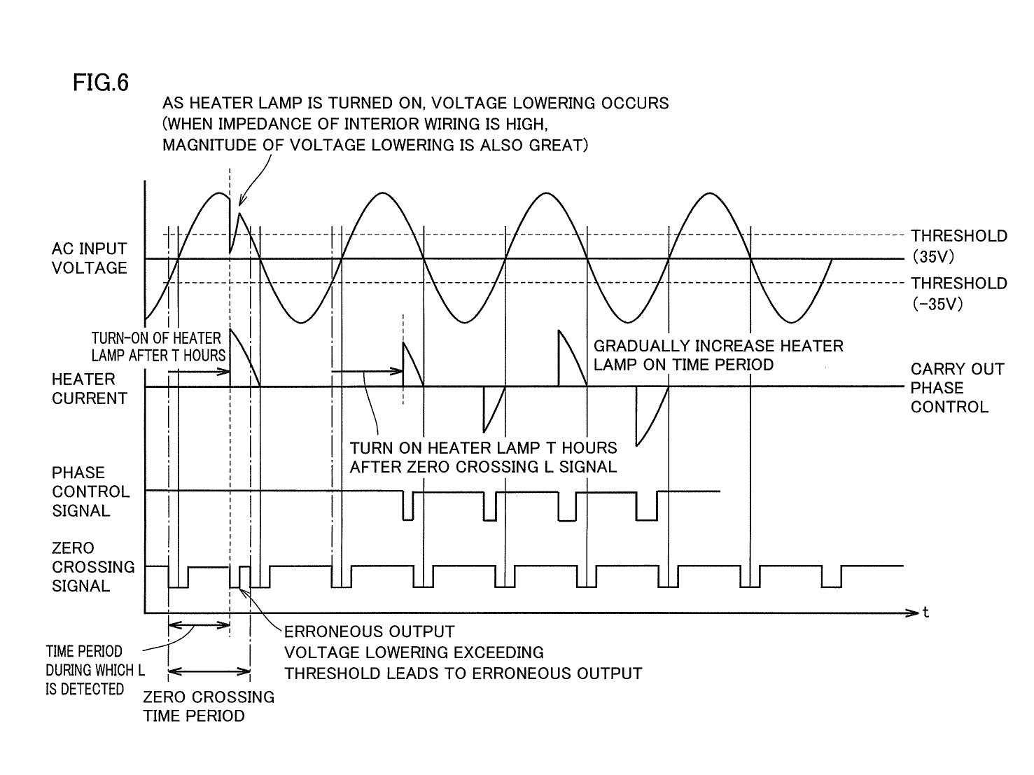

Another example of a voltage waveform and the like when heater lamp f3 according to the embodiment of the present invention is turned on will be described with reference to FIG. 6.

Referring to FIG. 6, here, a voltage waveform of an AC input voltage representing the external AC power supply, a heater current that flows in heater lamp f3, and a waveform of the zero crossing signal are shown.

As shown in FIG. 6, a zero crossing signal in conformity with the voltage waveform of the AC input voltage is output from zero crossing detection circuit 153. Specifically, when the AC input voltage is not lower than 35V in accordance with the threshold (threshold value) of +35V, −35V, the zero crossing signal is output at the “H” level, and when the AC input voltage is lower than 35V, the zero crossing signal is output at the “L” level. In the present embodiment, the external AC power supply is assumed to have a frequency of 50 Hz. In this case, the zero crossing time period representing the cycle of the zero crossing signal is 10 ms.

When the zero crossing signal is detected in accordance with the flow in FIG. 4, for example, when the “L” level of the zero crossing signal is detected, heater lamp f3 is turned on after prescribed time period T. With this turn-on, voltage lowering in the AC input voltage occurs. Here, when impedance of interior wiring representing an environment where printer 1 is used is high (overloaded state), magnitude of voltage lowering is great. Here, a case where voltage lowering is great is shown. Therefore, since voltage lowering at the time of turn-on of heater lamp f3 is great, variation in cycle of the zero crossing signal exceeding the threshold occurs. Namely, the cycle becomes shorter than the cycle serving as the reference of the original zero crossing signal. Thus, assuming that the erroneous detection of the zero crossing signal is present (YES in step S11), turn-on of heater lamp f3 is controlled under phase control.

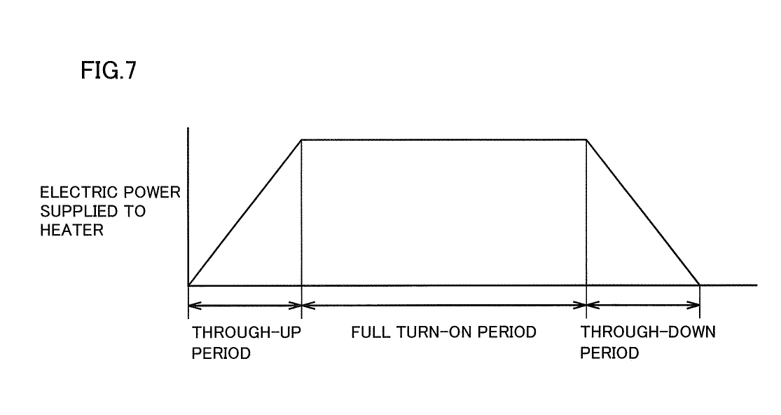

Electric power supplied to the heater lamp in phase control will be described with reference to FIG. 7.

Referring to FIG. 7, in a case where a temperature of heater lamp f3 is increased while impedance of interior wiring representing an environment where printer 1 is used is high (overloaded state), by gradually raising supplied electric power, the AC power supply is prevented from becoming unstable. In addition, in turning off heater lamp f3 as well, the AC power supply can be prevented from becoming unstable by gradually lowering supplied electric power under phase control.

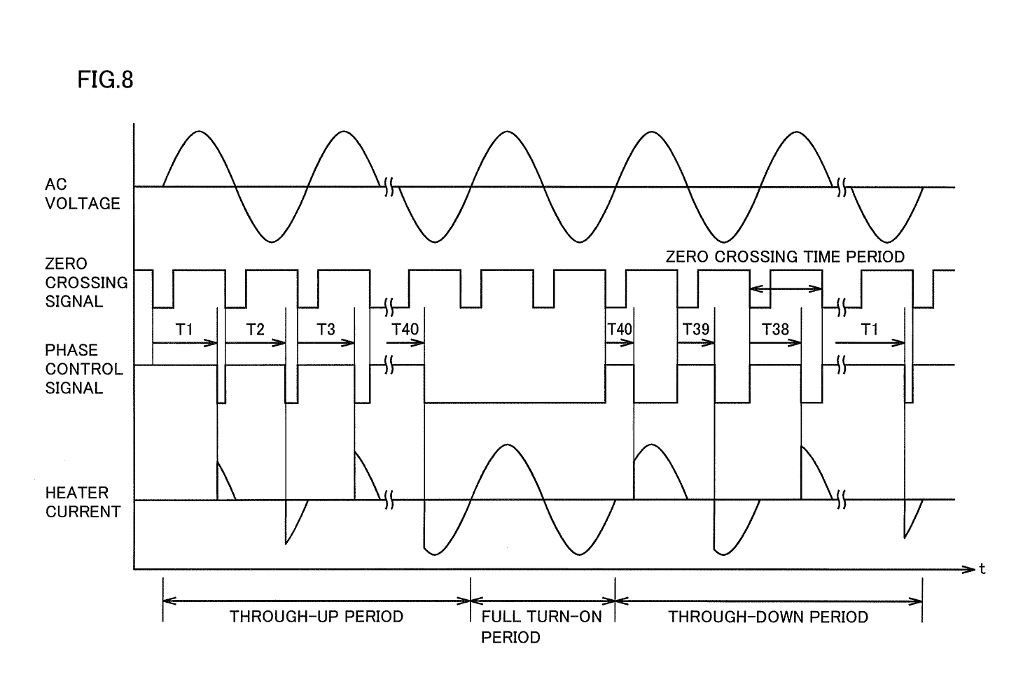

A phase control signal in phase control will be described with reference to FIG. 8.

Referring to FIG. 8, a case where timing of a phase control signal is gradually adjusted in increasing a temperature of heater lamp f3 under phase control is shown (T1 to T40) (a through-up period). On the other hand, a case where timing (phase angle) of the phase control signal is gradually adjusted also in turning off heater lamp f3 under phase control is shown (T40 to T1) (a through-down period).

The timing of the phase control signal can be set in advance in a table.

As shown in the drawing, in the case of phase control, a heater current becomes greater by gradually adjusting a phase angle. Therefore, electric power supplied to heater lamp f3 is gradually increased (through-up) and occurrence of such a malfunction as flickering of a fluorescent lamp due to the AC voltage becoming unstable can be prevented.

Thus, according to the present embodiment, when impedance of interior wiring representing an environment where printer 1 is used is high (overloaded state), phase control for controlling power feed to heater lamp f3 is carried out, so that occurrence of such a malfunction as flickering of a fluorescent lamp due to the AC voltage becoming unstable can be prevented. On the other hand, when impedance of interior wiring representing an environment where printer 1 is used is low (not in the overloaded state), zero crossing control for controlling power feed to heater lamp f3 is carried out, so that efficiency in turn-on of the heater can be enhanced and a period required to increase a temperature of heater lamp f3 to a prescribed temperature can be shortened.

Then, whether impedance of interior wiring representing an environment where printer 1 is used is high or low can be determined based on variation in cycle of the zero crossing signal. Therefore, an image forming apparatus capable of preventing, with a simplified technique, a power supply voltage from becoming unstable due to power feed to an electric heater provided therein can be realized, without requiring a special apparatus.

Though a case where the timing to turn on heater lamp f3 is set after a prescribed phase angle, with a period after the zero crossing signal having attained to the “L” level serving as the reference, has been described in the present embodiment, the embodiment is not particularly limited as such and a period after the zero crossing signal having attained to the “H” level may be adopted as the reference. Alternatively, the timing estimated to be a central point of the timing of switching of a signal (AC input voltage being 0) may be adopted as the reference. Since it is necessary to detect variation in cycle of the zero crossing signal, a prescribed phase angle is desirably set at timing other then the timing in a range between thresholds (that is, while the zero crossing signal is at the “L” level).

The present invention is not limited solely to the embodiment above, and it is susceptible to various modifications within the scope of the claims. For example, though a printer has been described in the embodiment above by way of example of an image forming apparatus according to the present invention, the present invention is not necessarily limited thereto. Namely, any image forming apparatus may be adopted as the image forming apparatus according to the present invention so long as it has a heating-type fixing device. By way of example, a multiple function peripheral (MFP) having a scanning function, a print function, a copy function, an e-mail print function, and the like may be adopted.

The image forming apparatus according to the present invention may be implemented by a dedicated hardware circuit for performing each procedure above, and a method of causing a computer to function to carry out control as described in the flow above or a program realizing the method can also be provided. Such a program may be recorded in a non-transitory computer-readable recording medium such as a flexible disc, a CD-ROM (Compact Disk-Read Only Memory), a ROM (Read Only Memory), a RAM (Random Access Memory), and a memory card, to be attached to a computer, and may be provided as a program product. Alternatively, a program may be provided as recorded in a recording medium such as a hard disk contained in a computer. Alternatively, a program may be provided by downloading through a network.

A program may invoke a necessary module from among program modules provided as a part of the operation system (OS) of the computer at prescribed timing in prescribed sequences and cause the module to perform processing. Here, the program itself does not include the module above but processing is performed in cooperation with the OS. Such a program not including a module may also be encompassed in the program according to the present invention.

In addition, the program according to the present invention may be provided as incorporated as a part of another program. In this case as well, the program itself does not include the module included in another program above but processing is performed in cooperation with another program. Such a program incorporated in another program may also be encompassed in the program according to the present invention.

A provided program product is installed in a program storage portion such as a hard disk and executed. It is noted that the program product includes a program itself and a recording medium recording a program.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image forming apparatus, comprising:
a fixing device having a heater;
a signal generator for generating a prescribed cyclic signal in conformity with a waveform of an AC power supply applied to said heater; and
a controller for controlling power feed to said heater, wherein
said controller determines whether a cycle of said prescribed cyclic signal becomes shorter than a prescribed period, and
when said controller has determined that said cycle has become shorter than said prescribed period, said controller controls power feed to said heater under phase control, and when said controller has determined that said cycle has not become shorter than said prescribed period, said controller controls power feed to said heater under zero crossing control.

2. The image forming apparatus according to claim 1, wherein
said signal generator generates a zero crossing signal in conformity with the waveform of said AC power supply.

3. The image forming apparatus according to claim 1, wherein
said controller causes power feed to said heater at a predetermined phase angle of said AC power supply.

4. The image forming apparatus according to claim 1, wherein
said controller determines whether the cycle of said prescribed cyclic signal becomes shorter than said prescribed period when power is fed to said heater.

5. A method of controlling an image forming apparatus provided with a fixing device having a heater, comprising:
a step of generating a prescribed cyclic signal in conformity with a waveform of an AC power supply applied to said heater;
a step of feeding power to said heater;
a step of determining whether a cycle of said prescribed cyclic signal becomes shorter than a prescribed period; and
a control step of controlling power feed to said heater under phase control when it has been determined that said cycle has become shorter than said prescribed period and controlling power feed to said heater under zero crossing control when it has been determined that said cycle has not become shorter than said prescribed period.

6. The method of controlling an image forming apparatus according to claim 5, wherein
in said step of generating a prescribed cyclic signal, a zero crossing signal in conformity with the waveform of said AC power supply is generated.

7. The method of controlling an image forming apparatus according to claim 5, wherein
in said step of feeding power to said heater, power is fed to said heater at a predetermined phase angle of said AC power supply.
